(19) United States
(12) Patent Application Publication
(10) Pub. No.: US 2003/0226653 A1
(43) Pub. Date: Dec. 11, 2003

(54) Structure for cooling high-voltage built-in units in hybrid vehicle

(75) Inventors: Harumi Takedomi, Utsunomiya-shi (JP); Osamu Hasegawa, Utsunomiya-shi (JP)

Correspondence Address: RANKIN, HILL, PORTER & CLARK, LLP, 700 HUNTINGTON BUILDING, 925 EUCLID AVENUE, SUITE 700, CLEVELAND, OH, 44115-1405, US

(73) Assignee: Honda Giken Kogyo Kabushiki Kaisha

(21) Appl. No.: 10/456,730

(22) Filed: Jun. 6, 2003

(30) Foreign Application Priority Data
Jun. 10, 2002 (JP) 2002-168448

(51) Int. Cl. B60H 3/00

(52) U.S. Cl. 165/43

(57) ABSTRACT

A structure for cooling one or more units built in a hybrid vehicle, where the structure is simple and can be inexpensively realized, and has a high cooling efficiency. The hybrid vehicle has an internal combustion engine and high-voltage units which include a motor which assists driving power of the engine and also functions as a power generator, a high-voltage storage battery for storing generated power, and a high-voltage controller provided between the motor and the storage battery. At least one of the high-voltage units is provided in an air intake passage for the engine, through which an air passes while cooling said at least one of the high-voltage units.

### BACKGROUND OF THE INVENTION

1. Field of the Invention

The present invention relates to a structure for cooling high-voltage units built in a hybrid vehicle, such as a high-voltage battery, a high-voltage controller, a motor, and the like.

2. Description of the Related Art

Japanese Unexamined Patent Application, First Publication No. 2002-4860 discloses a structure for cooling units built in a hybrid vehicle, in which water jackets are attached to each high-voltage unit, such as an electric motor, an inverter, and the like, and the cooling operation is performed by using both the internal combustion engine and the cooling water. This cooling system has a radiator and a radiator fan which are dedicatedly provided for the high-voltage units and thus are independent of the internal combustion engine, and the system also has a dedicated electric pump and a dedicated throttle valve for controlling temperature, thereby controlling the temperature of the cooling water, which is suitable for the high-voltage units.

However, in the above conventional structure for cooling the units built in the hybrid vehicle, a cooling system independent of the internal combustion engine is necessary, so that the piping arrangement and the control are complicated. In addition, the dedicated water jacket, electric pump, radiator fan, and the like are necessary for each high-voltage unit, thereby increasing the weight of the vehicle.

Additionally, the control temperatures for the high-voltage units are generally lower than the control temperature for the internal combustion engine. Here, the control temperature is an optimal temperature which is determined for each unit or device and is maintained by control. Therefore, it is necessary to cool the cooling water to have a temperature suitable for the high-voltage units, and thus the operation of this cooling system is inefficient.

### SUMMARY OF THE INVENTION

In consideration of the above circumstances, an object of the present invention is to provide a structure for cooling one or more units built in a hybrid vehicle, where the structure is simple and can be inexpensively realized, and has a high cooling efficiency.

Therefore, the present invention provides a structure for cooling high-voltage units built in a hybrid vehicle, wherein:

the hybrid vehicle comprises an internal combustion engine (e.g., an engine 4 in an embodiment explained below) and high-voltage units which include a motor (e.g., a motor 8 in the embodiment explained below) which assists driving power of the engine and also functions as a power generator, a high-voltage storage battery (e.g., a storage battery 9 in the embodiment explained below) for storing generated power, and a high-voltage controller (e.g., a high-voltage controller 11 in the embodiment explained below) provided between the motor and the storage battery; and

at least one of the high-voltage units is provided in an air intake passage (e.g., an air intake passage 6 in the embodiment explained below) for the engine, through which an air passes while cooling said at least one of the high-voltage units.

According to the above structure, the intake air for the engine can be used as the cooling air for cooling the motor, the storage battery, and the high-voltage controller which are arranged in the air intake passage. Each high-voltage unit is provided in the air intake passage of the engine compartment; thus, the space necessary for arranging the units can be saved. Therefore, the structure can be efficiently built into a hybrid vehicle.

Preferably, at least two of the high-voltage units are arranged in the air intake passage, which starts from an air intake inlet (e.g., an air intake inlet 16 in the embodiment explained below) and reaches the engine, in order of a control temperature from the lowest to the highest, where the control temperature is an optimal temperature determined for each unit, which is maintained by control.

In this case, as a typical example, the storage battery, the high-voltage controller, and the motor are arranged in this order in the air intake passage which starts from the air intake inlet and reaches the engine.

Accordingly, the high-voltage units can be arranged from the upstream side of the air intake passage, in order of the control temperature from the lowest to the highest; therefore, each unit can be efficiently cooled by the air which is drawn from the air intake inlet and which passes through the air intake passage.

The high-voltage controller may include at least one of an inverter, a DC-DC converter, and an electronic control unit for the motor.

As a preferable example:

an air cleaner unit for cleaning the air is provided in the air intake passage; and

a case of the air cleaner unit has an opening to which the high-voltage controller is attached in a sealed state so as to close the opening.

In this case, the air cleaner unit may have cooling fins for assisting the flow of the air, which protrude towards an inner space of the air cleaner unit.

### BRIEF DESCRIPTION OF THE DRAWINGS

FIG. 1 is a plan view showing the general structure of the engine compartment of a hybrid vehicle in an embodiment according to the present invention.

FIG. 2 is a plan view for showing and explaining the cooling structure in the embodiment.

FIG. 3 is a sectional view in a horizontal direction of the air cleaner case in the embodiment.

FIG. 4 is a side view which is viewed along the direction indicated by arrow A in FIG. 3.

FIG. 5 is a sectional view in a horizontal direction of the motor in the embodiment.

FIG. 6 is a sectional view taken along line B-B in FIG. 5.

FIG. 7 is a sectional view taken along line C-C in FIG. 5.

### DESCRIPTION OF THE PREFERRED EMBODIMENTS

Hereinafter, an embodiment according to the present invention will be explained with reference to the drawings.

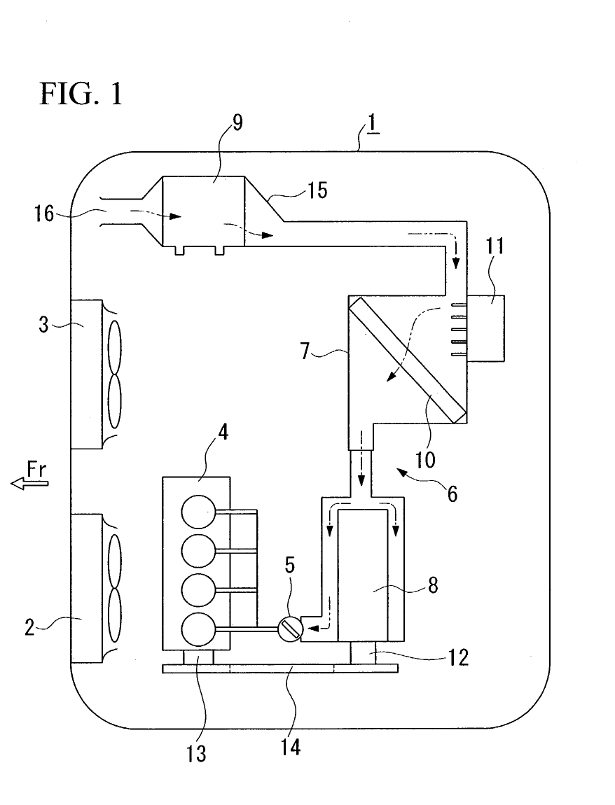

FIG. 1 is a diagram showing the general structure of the engine compartment 1 of a hybrid vehicle in the present embodiment. In this hybrid vehicle, the current of the storage battery 9 as a DC (direct current) power supply is converted from DC to AC (alternating current) by using an inverter provided in the high-voltage control unit 11, and the converted current is supplied to the motor 8. This motor 8 is used as a generator, and a portion of the power output from the engine or the kinetic energy of the vehicle is regenerated. The voltage of the regenerated power is boosted using a DC-DC converter in the high-voltage control unit 11 and is then stored in the storage battery 9 via the inverter.

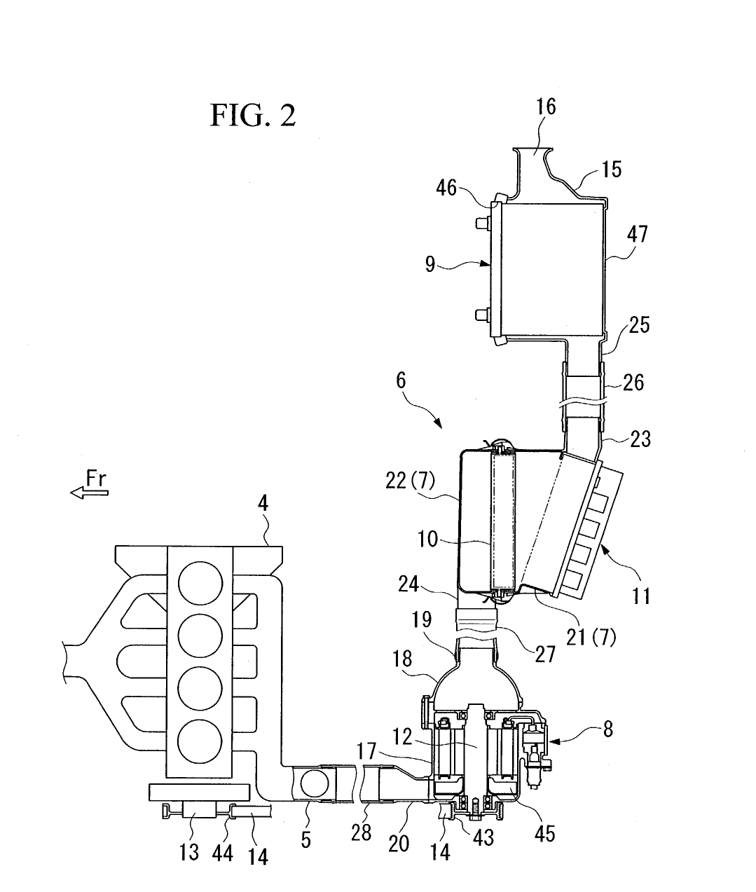

In the front portion of the engine compartment 1, a radiator 2 for the engine is provided at the left side, and a condenser 3 for the air-conditioner is provided at the relatively right side. The arrow “Fr” in FIG. 1 (also in FIGS. 2, 3, and 5 which will be explained below) indicates the front side of the vehicle.

The engine 4 is provided behind the radiator 2, and an air intake passage 6 is provided, which is arranged from behind the throttle body 5 of the engine 4, in the counterclockwise direction in the engine compartment 1.

In the air intake passage 6, the motor 8 is positioned at the downstream side (with respect to the air flow) of the air cleaner case 7, and the storage battery 9 is positioned at the upstream side of the air cleaner case 7. In addition, the high-voltage controller 11 is positioned in the air cleaner case 7 (the detailed structure will be explained below) and at the upstream side of the air cleaner element 10. Therefore, in the air intake passage 6 of the engine 4, the storage battery 9, the high-voltage controller 11, and the motor 8 are arranged in turn from the upstream side.

The engine 4 is laid on its side, and the motor 8 is arranged behind the engine 4 in parallel to the engine 4. The drive shaft 12 of the motor 8 and the crank shaft 13 of the engine 4 are coupled via the belt 14. Therefore, when the electrical power is supplied to the motor 8, the driving power of the engine 4 is assisted via the belt 14. In addition, when the vehicle is decelerated, kinetic energy is supplied from the crank shaft 13 of the engine 4 via the belt 14 to the motor 8, and a portion of the supplied kinetic energy is regenerated as electrical power. Here, this motor 8 also functions as a starter of the engine 4.

The air cleaner case 7 is provided at the right side of the motor 8, and the air intake duct 15 is provided at the front right side of the air cleaner case 7. The storage battery 9 is positioned in the air intake duct 15.

The air intake inlet 16 of the air intake duct 15 is provided at the right side and the frontmost portion of the engine compartment 1, so as not to receive the exhaust air from the radiator 2 and the condenser 3. The air intake inlet 16 is open towards the front side.

Below, with reference to FIGS. 2 to 7, the concrete structure of the cooling system according to the present embodiment will be explained.

As shown in FIG. 2, the motor 8 has a substantially cylindrical shape, where the drive shaft 12 is provided in the axial direction of the cylindrical shape. The motor 8 has a housing 17 and a diffuser 18 which is attached to the right-side end of the housing 17 and which extends in the direction of the drive shaft 12.

At the head of the diffuser 18 in the direction of the drive shaft 12, an air-take inport 19 is provided, and an air intake outport 20 is provided at the left-side end of the housing 17 and in the side wall which faces the engine 4.

In the air cleaner case 7, the cover 22 is attached to the front portion of the case main body 21, thereby forming a closed space having a substantially box shape. The air cleaner element 10 is provided in the air cleaner case 7 and between the case main body 21 and the cover 22.

An air intake inport 23 is attached to the right side wall of the case main body 21, and an air intake outport 24 is attached to the left side wall of the cover 22.

The air intake inlet 16, which is open towards the front side (in FIG. 2, towards the right side for convenience of illustration), is formed in the air intake duct 15, and an air intake outport 25 is formed at the side opposite to the side where the air intake inlet 16 is provided.

The outport 25 of the air intake duct 15 and the inport 23 of the air cleaner case 7 are coupled with each other via a pipe 26, the outport 24 of the air cleaner case 7 and the inport 19 of the motor 8 are coupled with each other via a pipe 27, and the outport 20 of the motor 8 and the throttle body 5 of the engine 4 are coupled with each other via a pipe 28, so that the air intake passage 6 is continuously formed from the air intake inlet 16 to the throttle body 5.

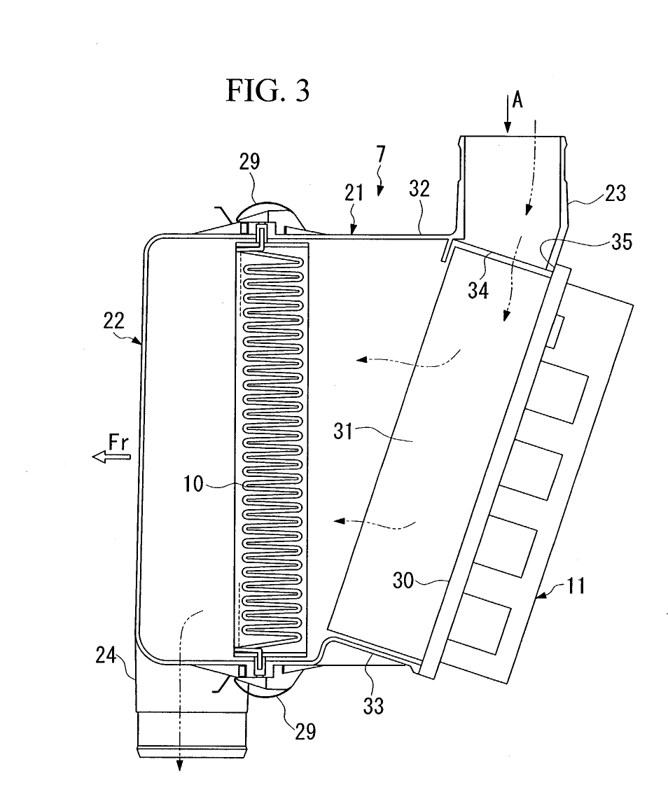

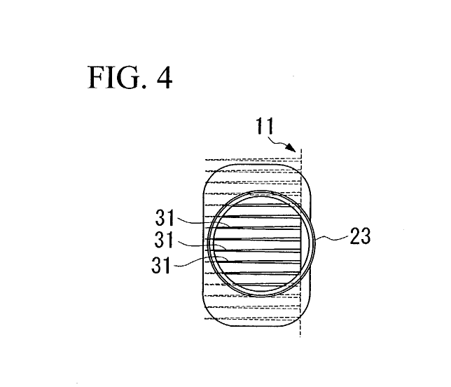

As shown in FIGS. 3 and 4, in the air cleaner case 7, the cover 22 is attached to the case main body 21 by using clips 29, and the dry air cleaner element 10 is fastened between the case main body 21 and the cover 22.

The rear wall portion 30 of the case main body 21 is open in this embodiment, and the high-voltage controller 11 is attached so as to close the rear wall portion 30. That is, the high-voltage controller 11 functions as a part of the case main body 21.

The high-voltage controller 11 includes an inverter, a DC-DC converter, a motor ECU (electronic control unit), and the like, and has a thin shape so as not to increase the size of the air cleaner case 7. Here, the motor ECU controls the amounts of power assistance, regeneration, and the like of the motor, via the inverter.

The high-voltage controller 11 has a plurality of cooling fins 31 which protrude towards the inner space of the air cleaner case 7. This high-voltage controller 11 is inclined with respect to the air-drawing direction of the inport 23 of the air cleaner case 7, so that the high-voltage controller 11 can more easily receive the air.

The cooling fins 31 is arranged from the right side wall 32 to the left side wall 33 of the case main body 21 and is arranged substantially parallel to the air-drawing direction of the inport 23 (see FIG. 4).

In FIG. 3, the inport 23 is arranged in a manner such that an end of the opening 34 of the inport 23 contacts the rear edge 35 of the right side wall 32, that is, contacts the high-voltage controller 11. In addition, the cooling fins 31 of the high-voltage controller 11 protrude in a manner such that the protruding fins secure a height (measured from the end which contacts the rear edge 35) up to the other end of the opening 34.

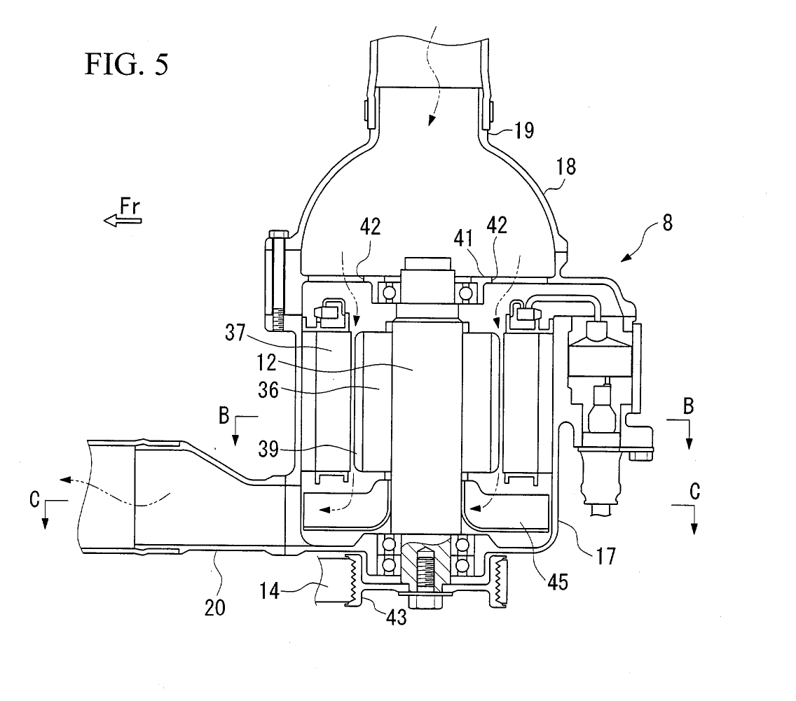

As shown in FIG. 5, the housing 17 forms the outer shape of the motor 8, where the motor 8 may be a three-phase motor. That is, the housing 17 is a constituent of the motor 8 and forms a closed space inside the housing.

The rotor 36 and the stator 37 are provided in a center portion in the right-left direction of the housing 17. The drive shaft 12 is coupled with the rotor 36 and is rotatably supported by the housing 17. The three-phase wound stator 37 is fixedly supported by the housing 17.

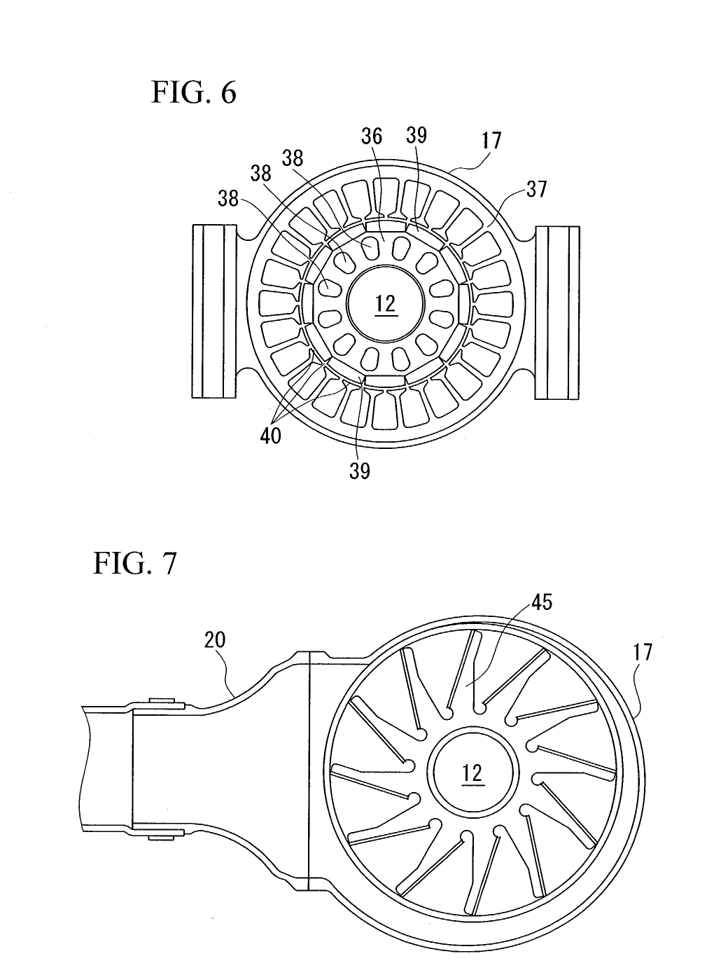

As shown in FIG. 6, a plurality of air-drawing portions 38 are provided in the rotor 36, which are arranged parallel to the drive shaft 12, so that the air drawn into the housing 17 can pass through the air-drawing portions 38. In addition, the gap 40 between the magnets 39 connected to the rotor 36 and the stator 37 also functions as an air passage.

As shown in FIG. 5, in the right side wall 41 of the housing 17, a plurality of air holes 42 are provided, and the diffuser 18 is connected to the right side wall 41 in a sealed state so that no gap is present between the wall and the diffuser. Accordingly, the air, which is drawn into the housing 17 via the diffuser 18, passes through the air-drawing portions 38 and the gap 40 and is then transferred to the outport 20.

At the left side of the housing 17, a pulley 43 is provided, which is coupled with the drive shaft 12, and at the left side of the engine 4, a pulley 44 is provided, which is coupled with the crank shaft 13 (see FIG. 2). In addition, the belt 14 is provided around the pulleys 43 and 44 so as to couple the engine 4 and the motor 8 with each other.

At the right-side end of the housing 17, a fan 45 coupled with the drive shaft 12 is provided. This fan 45 is operated together with the drive shaft 12 of the motor 8, thereby promoting the air intake operation. The fan 45 also functions as a supercharger for forcing the air into the outport 20 which is provided at the left-side end of the housing 17 (see FIG. 7).

As shown in FIG. 2, the air intake duct 15 has a container 47 which has an opening 46. This container 47 is an expanded portion in the air intake duct 15, and the storage battery 9 is provided in this expanded portion.

The portion (or gap) between the storage battery 9 and the opening 46 is sealed, so that the air drawn from the air intake inlet 16 passes through a gap between the air intake duct 15 and the storage battery 9 and is then drawn into the air cleaner case 7.

The operation of the present embodiment will be explained below.

When the engine 4 is started, the air is drawn from the air intake inlet 16 into the air intake duct 16, as indicated by chain arrows (drawn with two-dot chain lines) in FIG. 1. In this process, the drive shaft 12 of the motor 8 rotates via the belt 14, and accordingly, the fan 45 is operated, so that the inside of the air intake passage 6 has a negative pressure and the air intake operation is progressed.

The storage battery 9 in the air intake duct 15 is cooled by the air drawn from the air intake inlet 16. Here, the air intake inlet 16 is positioned at the frontmost portion of the vehicle body and thus does not receive the exhaust air from the radiator 2 and the condenser 3 and the heat of the engine 4 and the like, so that it is possible to maintain the temperature of the air drawn from the air intake inlet 16 at a suitable low level.

The air which has cooled the storage battery 9 is discharged from the outport 25 and is supplied to the air cleaner case 7 via the pipe 26. The high-voltage controller 11 is cooled by the air drawn into the air cleaner case 7 from the inport 23. Here, the control temperature for the storage battery 9 is lower than the control temperature for the high-voltage controller 11; thus, the high-voltage controller 11 can be cooled by the air which has been subjected to the heat exchange with the storage battery 9.

The high-voltage controller 11 is inclined with respect to the air-drawing direction of the inport 23; thus, the high-voltage controller 11 can easily receive the air. In addition, the cooling fins 31 are arranged in substantially parallel to the air-drawing direction of the inport 23; thus, the air easily flows along the cooling fins 31. Therefore, the high-voltage controller 11 can be efficiently cooled by the air drawn from the inport 23.

Additionally, the high-voltage controller 11 is provided at the upstream side of the air cleaner case 7, and the cooling fins 31 are provided so as to cover the height from one end to the other end of the opening 34 of the inport 23 (refer to FIG. 3). Therefore, the cooling fins 31 themselves function as a simplified filter. Therefore, it is possible to prevent dust of relatively large particle size from entering the air cleaner case 7 and to reduce dirt on the air cleaner element 10.

The air, which has cooled the high-voltage controller 11, passes through the air cleaner element 10 and is discharged from the outport 24. This discharged air is supplied to the motor 8 via the pipe 27. The air drawn from the inport 19 of the diffuser 18 into the housing 17 passes in the direction along the drive shaft 12, thereby cooling the motor 8. Here, the control temperature for the high-voltage controller 11 is lower than that of the motor 8; thus, the air, which has been subjected to the heat exchange with the high-voltage controller 11, can cool the motor 8.

Here, the motor 8 is provided at the downstream side of the air cleaner element 10; thus, it is possible to prevent foreign objects from entering the housing 17 together with the air.

The air which has cooled the motor 8 passes through the fan 45 and is discharged from the outport 20. This overpressurized air is supplied to the throttle body 5 via the pipe 28.

According to the above-explained embodiment, the high-voltage units such the storage battery 9, the high-voltage controller 11, and the motor 8 can be cooled without providing a dedicated cooling system. Therefore, the cooling structure, which is light and inexpensive, can be realized using a small number of parts.

In addition, each high-voltage unit is positioned in the air intake passage 6; thus, the space necessary for arranging the units can be saved, and it is unnecessary to ensure a space for arranging the units in an interior of the vehicle or the like. Therefore, the space in the interior of the vehicle can be effectively used.

In the above embodiment, the high-voltage units are arranged from the upstream side in order of the control temperature from the lowest to the highest. Therefore, each unit can be efficiently cooled by the same air.

In addition, the operation of the fan 45 can progress the air intake operation and thus improve the efficiency of cooling the storage battery 9, the high-voltage controller 11, and the motor 8 in the air intake passage 6, This fan 45 also functions as a supercharger; thus, the performance of the engine can be improved.

Also in the above embodiment, the high-voltage controller 11 is attached so as to form a part of the air cleaner case 7; thus, the rigidity of the faces of the air cleaner case 7 can be improved and sounds (or noises) generated during the air intake operation can be reduced. In addition, the cooling fins 31 are provided towards the inner space of the air cleaner case 7; thus, the space in the air cleaner case 7 can be effectively used.

The present invention is not limited to the above-explained embodiment, and modifications are possible within the scope and spirit of the present invention.

For example, if all of the storage battery 9, the high-voltage controller 11, and the motor 8 cannot be arranged in the air intake passage 6, at least one of these units may be provided in the air intake passage 6. In addition, the motor 8 is cooled in the housing 17 in the above embodiment; however, the motor 8 (which has the housing 17) may be contained in the air intake passage 6 and the motor 8 may be cooled from the outside of the housing 17.

In another variation, a clutch may be provided in the transmission system for the motor 8 and the engine 4, so that the power transmission between the drive shaft 12 of the motor 8 and the crank shaft 13 of the engine 4 can be connected and disconnected.

In another variation, the motor 8 and the engine 4 may be coupled using a combination of a chain and a sprocket instead of the combination of the pulleys 43 and 44 and the belt 14.

What is claimed is:

1. A structure for cooling high-voltage units built in a hybrid vehicle, wherein:
the hybrid vehicle comprises an internal combustion engine and high-voltage units which include a motor which assists driving power of the engine and also functions as a power generator, a high-voltage storage battery for storing generated power, and a high-voltage controller provided between the motor and the storage battery; and
at least one of the high-voltage units is provided in an air intake passage for the engine, through which an air passes while cooling said at least one of the high-voltage units.

2. A structure as claimed in claim 1, wherein at least two of the high-voltage units are arranged in the air intake passage, which starts from an air intake inlet and reaches the engine, in order of a control temperature from the lowest to the highest, where the control temperature is an optimal temperature determined for each unit, which is maintained by control.

3. A structure as claimed in claim 2, wherein the storage battery, the high-voltage controller, and the motor are arranged in this order in the air intake passage which starts from the air intake inlet and reaches the engine.

4. A structure as claimed in claim 1, wherein the high-voltage controller includes at least one of an inverter, a DC-DC converter, and an electronic control unit for the motor.

5. A structure as claimed in claim 1, wherein:
an air cleaner unit for cleaning the air is provided in the air intake passage; and
a case of the air cleaner unit has an opening to which the high-voltage controller is attached in a sealed state so as to close the opening.

6. A structure as claimed in claim 5, wherein the air cleaner unit has cooling fins for assisting the flow of the air, which protrude towards an inner space of the air cleaner unit.
